(19) United States
(12) Patent Application Publication
(10) Pub. No.: US 2005/0285866 A1
(43) Pub. Date: Dec. 29, 2005

(54) Display-wide visual effects for a windowing system using a programmable graphics processing unit

(75) Inventors: Ralph Brunner, Cupertino, CA (US); John Harper, San Francisco, CA (US)

Correspondence Address: WONG, CABELLO, LUTSCH, RUTHERFORD & BRUCCULERI,;P.C., 20333 SH 249, SUITE 600, HOUSTON, TX, 77070, US

(73) Assignee: Apple Computer, Inc., Cupertino, CA (US)

(21) Appl. No.: 10/877,358

(22) Filed: Jun. 25, 2004

(51) Int. Cl. G09G 5/37; G06F 13/00

(52) U.S. Cl. 345/537

(57) ABSTRACT

Techniques to effect arbitrary visual effects using fragment programs executing on a programmable graphics processing unit are described. In a first technique, visual effects are applied to a buffered window system's assembly buffer prior to compositing a target window. In a second technique, visual effects are applied to a target window as it is being composited into the system's assembly buffer. In a third technique, visual effects are applied to a system's assembly buffer after compositing a target window. Finally, in a fourth technique, visual effects are applied to the system's assembly buffer as it is transmitted to the system's frame-buffer.

### BACKGROUND

The invention relates generally to computer display technology and, more particularly, to the application of visual effects using a programmable graphics processing unit during frame-buffer composition in a computer system. The subject matter of the invention is generally related to the following jointly owned and co-pending patent applications: “System for Reducing the Number of Programs Necessary to Render an Image,” by John Harper, Ser. No. 10/826,773; “System for Optimizing Graphics Operations” by John Harper, Ralph Brunner, Peter Graffagnino, and Mark Zimmer, Ser. No. 10/825,694; “System for Emulating Graphics Operations,” by John Harper, Ser. No. 10/826,744; and “High-Level Program Interface for Graphics Operations,” by John Harper, Ralph Brunner, Peter Graffagnino, and Mark Zimmer, Ser. No. 10/826,762, each incorporated herein by reference in its entirety.

Referring to FIG. 1, in prior art buffered window computer system 100, each application (e.g., applications 105 and 110) has associated with it one or more window buffers or backing stores (e.g., buffers 115 and 120—only one for each application is shown for convenience). Backing store's represent each application's visual display. Applications produce a visual effect (e.g., blurring or distortion) through manipulation of their associated backing store. At the operating system (“OS”) level, compositor 125 combines each application's backing store (in a manner that maintains their visual order) into a single “image” stored in assembly buffer 130. Data stored in assembly buffer 130 is transferred to frame buffer 135 which is then used to drive display unit 140. As indicated in FIG. 1, compositor 125 (an OS-level application) is implemented via instructions executed by computer system central processing unit (“CPU” 145.

Because of the limited power of CPU 145, it has not been possible to provide more than rudimentary visual effects (e.g., translucency) at the system or display level. That is, while each application may effect substantially any desired visual effect or filter to their individual window buffer or backing store, it has not been possible to provide OS designers the ability to generate arbitrary visual effects at the screen or display level (e.g., by manipulation of assembly buffer 130 and/or frame buffer 135) without consuming virtually all of the system CPU's capability—which can lead to other problems such as poor user response and the like.

Thus, it would be beneficial to provide a mechanism by which a user (typically an OS-level programmer or designer) can systematically introduce arbitrary visual effects to windows as they are composited or to the final composited image prior to its display.

### SUMMARY

Techniques in accordance with the invention provide four (4) types of visual effects at the system or display level. In the first, visual effects are applied via a programmable graphics processing unit to a buffered window system's assembly buffer prior to compositing a target window. In the second, visual effects are applied via a programmable graphics processing unit to a target window as it is being composited into the system's assembly buffer. In the third, visual effects are applied via a programmable graphics processing unit to a system's assembly buffer after compositing a target window. And in the fourth, visual effects are applied via a programmable graphics processing unit to the system's assembly buffer as it is transmitted to the system's frame-buffer for display. Techniques in accordance with the invention provide a means to affect a computer system's entire display and may employ substantially any known visual effect.

### BRIEF DESCRIPTION OF THE DRAWINGS

FIG. 1 shows a prior art buffered window computer system.

FIG. 2 shows a buffered window computer system in accordance with one embodiment of the invention.

FIGS. 3A and 3B show a below-effect in accordance with one embodiment of the invention.

FIGS. 4A and 4B show an on-effect in accordance with one embodiment of the invention.

FIGS. 5A and 5B show an on-effect in accordance with another embodiment of the invention.

FIGS. 6A and 6B show an above-effect in accordance with one embodiment of the invention.

FIGS. 7A and 7B show a full-screen effect in accordance with one embodiment of the invention.

FIG. 8 shows, in block diagram form, a display whose visual presentation has been modified in accordance with the invention.

FIG. 9 shows, in flowchart form, an event processing technique in accordance with one embodiment of the invention.

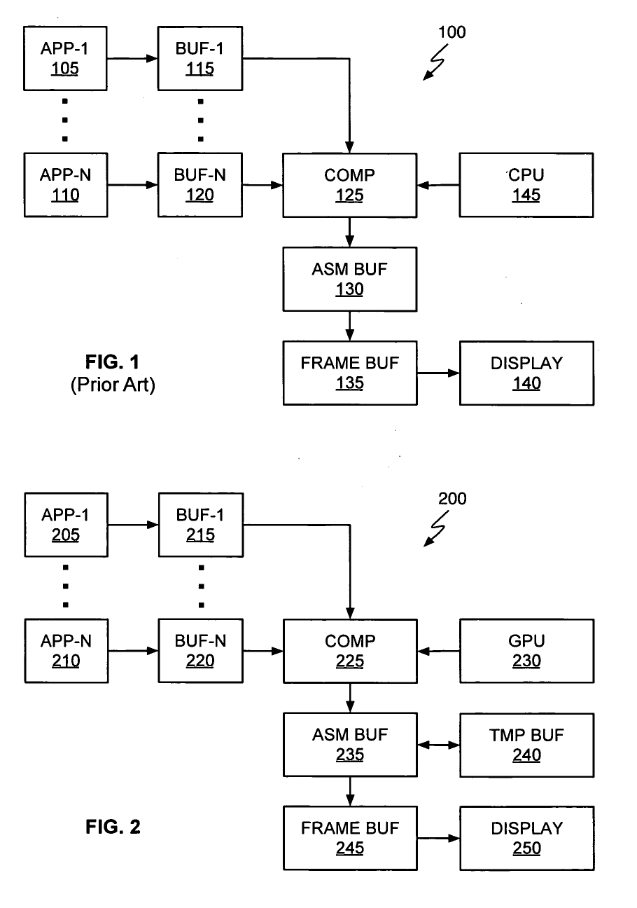

### DETAILED DESCRIPTION

Methods and devices to generate arbitrary display-wide visual effects using fragment programs executing on a programmable graphics processing unit are described. The effects may be made to windows composited beneath a target window, congruent with compositing a target window, to windows composited after a target window or to an entire composited image substantially immediately prior to its display. The following embodiments of the invention, described in terms of the Mac OS X window server and compositing application, are illustrative only and are not to be considered limiting in any respect. (The Mac OS X operating system is developed, distributed and supported by Apple Computer, Inc. of Cupertino, Calif.)

Referring to FIG. 2, buffered window computer system 200 in accordance with one embodiment of the invention includes a plurality of applications (e.g., applications 205 and 210), each of which is associated with one or more backing stores, only one of which is shown for clarity and convenience (e.g., buffers 215 and 220). Compositor 225 (one component in an OS-level “window server” application) uses fragment programs executing on programmable graphics processing unit (“GPU”) 230 to combine, or composite, each application's backing store into a single “image” stored in assembly buffer 235 in conjunction with, possibly, temporary buffer 240. Data stored in assembly buffer 235 is transferred to frame buffer 245 which is then used to drive display unit 250. In accordance with one embodiment, compositer 225/GPU 230 may also manipulate a data stream as it is transferred into frame buffer 245 to produce a desired visual effect on display 250.

As used herein, a “fragment program” is a collection of program statements designed to execute on a programmable GPU. Typically, fragment programs specify how to compute a single output pixel—many such fragments being run in parallel on the GPU to generate the final output image. Because many pixels are processed in parallel, GPUs can provide dramatically improved image processing capability (e.g., speed) over methods that rely only on a computer system's CPU (which is also responsible for performing other system and application duties).

Techniques in accordance with the invention provide four (4) types of visual effects at the system or display level. In the first, hereinafter referred to as “before-effects,” visual effects are applied to a buffered window system's assembly buffer prior to compositing a target window. In the second, hereinafter referred to as “on-effects,” visual effects are applied to a target window as it is being composited into the system's assembly buffer or a filter is used that operates on two inputs at once to generate a final image—one input being the target window, the other being the contents of the assembly buffer. In the third, hereinafter referred to as “above-effects,” visual effects are applied to a system's assembly buffer after compositing a target window. And in the fourth, hereinafter referred to as “full-screen effects,” visual effects are applied to the system's assembly buffer as it is transmitted to the system's frame-buffer for display.

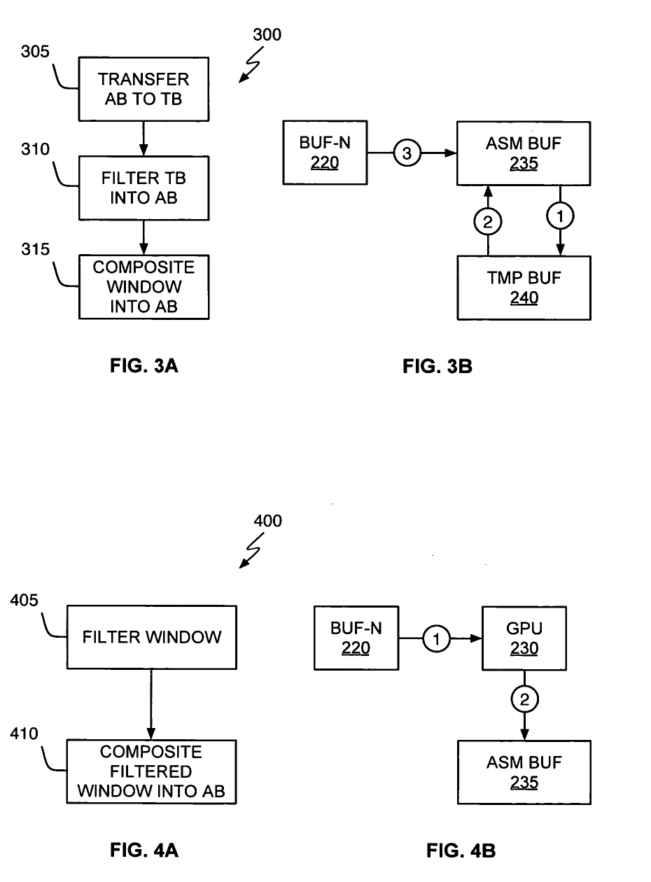

Referring to FIGS. 3A and 3B, below-effect 300 in accordance with one embodiment of the invention is illustrated. In below-effect 300, the windows beneath (i.e., windows already composited and stored in assembly buffer 235) a target window (e.g., contained in backing store 220) are filtered before the target window (e.g., contained in backing store 220) is composited. As shown, the contents of assembly buffer 235 are first transferred to temporary buffer 240 by GPU 230 (block 305 in FIG. 3A and\textcircled{1} in FIG. 3B). GPU 230 then filters the contents of temporary buffer 240 into assembly buffer 235 to apply the desired visual effect (block 310 in FIG. 3A and \textcircled{2} in FIG. 3B). Finally, the target window is composited into (i.e., on top of the contents of) assembly buffer 235 by GPU 230 (block 315 and \textcircled{3} in FIG. 3B). It will be noted that because the target window is composited after the visual effect is applied, below-effect 300 does not alter or impact the target window. Visual effects appropriate for a below-effect in accordance with the invention include, but are not limited to, drop shadow, blur and glass distortion effects. It will be known by those of ordinary skill that a filter need not be applied to the entire contents of the assembly buffer or target window. That is, only a portion of the assembly buffer and/or target window need be filtered. In such cases, it is known to use the bounding rectangle or the alpha channel of the target window to determine the region that is to be filtered.

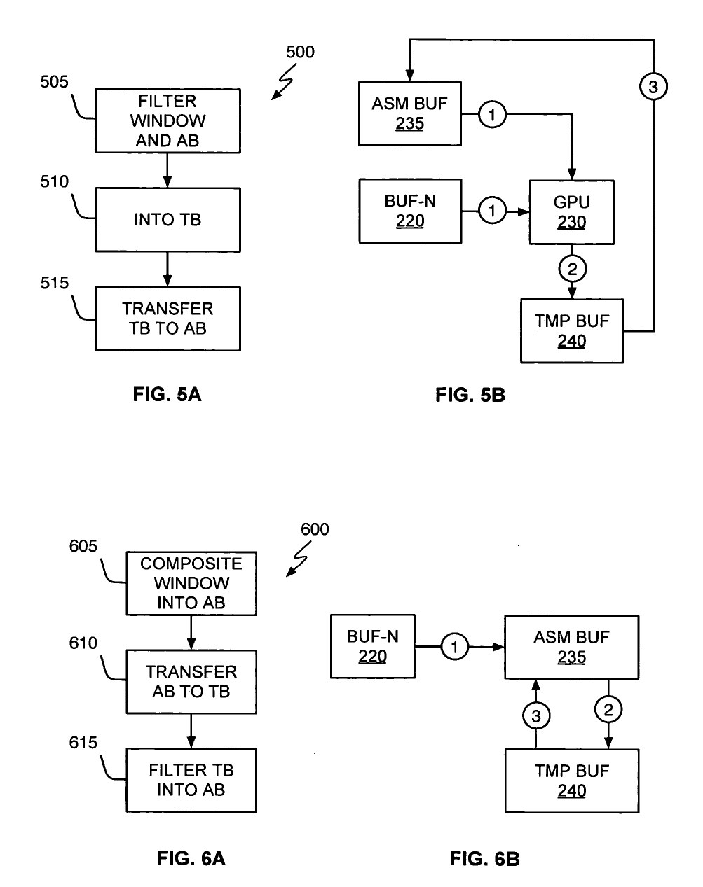

Referring to FIGS. 4A and 4B, on-effect 400 in accordance with one embodiment of the invention is illustrated. In on-effect 400, a target window (e.g., contained in backing store 220) is filtered as it is being composited into a system's assembly buffer. As shown, the contents of window buffer 220 are filtered by GPU 230 (block 405 in FIG. 4A and \textcircled{1} in FIG. 4B) and then composited into assembly buffer 235 by GPU 230 (block 410 in FIG. 4A and \textcircled{2} in FIG. 4B). Referring to FIGS. 5A and 5B, on-effect 500 in accordance with another embodiment of the invention is illustrated. In on-effect 500, a target window (e.g., contained in backing store 220) and assembly buffer 235 (block 505 in FIG. 5A and \textcircled{1} in FIG. 5B) are filtered into temporary buffer 240 (block 510 in FIG. 5A and \textcircled{2} in FIG. 5B). The resulting image is transferred back into assembly buffer 235 (block 515 in FIG. 5A and \textcircled{3} in FIG. 5B). Visual effects appropriate for an on-effect in accordance with the invention include, but are not limited to, window distortions and color correction effects such as grey-scale and sepia tone effects.

Referring to FIGS. 6A and 6B, above-effect 600 in accordance with one embodiment of the invention is illustrated. In above-effect 600, the target window (e.g., contained in backing store 220) is composited into the system's assembly buffer prior to the visual effect being applied. Accordingly, unlike below-effect 300, the target window may be affected by the visual effect. As shown, the target window is first composited into assembly buffer 235 by GPU 230 (block 605 in FIG. 6A and \textcircled{1} in FIG. 6B), after which the result is transferred to temporary buffer 240 by GPU 230 (block 610 in FIG. 6A and \textcircled{2} in FIG. 6B). Finally, GPU 230 filters the contents of temporary buffer 240 into assembly buffer 235 to apply the desired visual effect (block 615 in FIG. 6A and \textcircled{3} in FIG. 6B). Visual effects appropriate for an on-effect in accordance with the invention include, but are not limited to, glow effects.

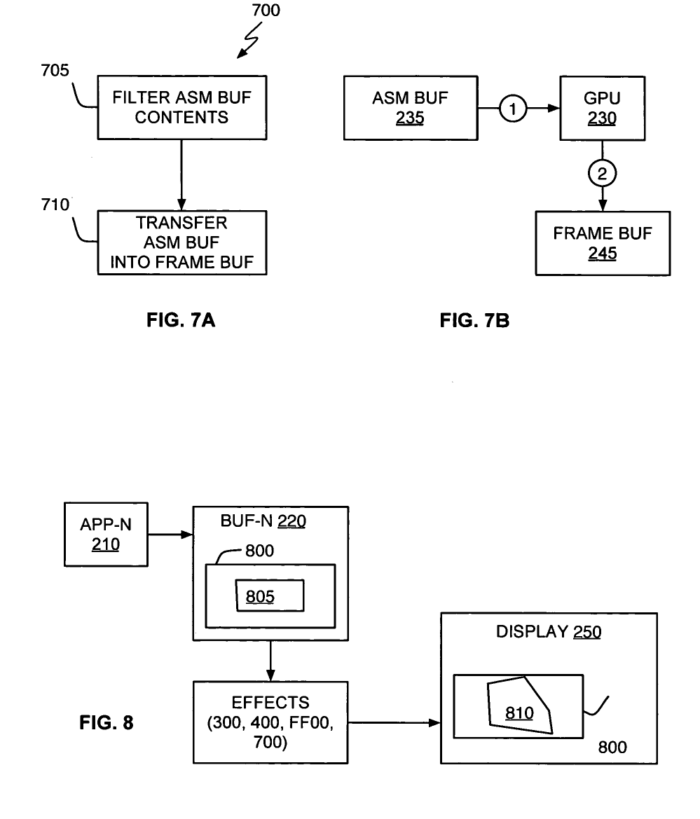

Referring to FIGS. 7A and 7B, full-screen effect 700 in accordance with one embodiment of the invention is illustrated. In full-screen effect 700, the assembly buffer is filtered as it is transferred to the system's frame buffer. As shown, the contents of assembly buffer 235 are filtered by GPU 230 (block 705 in FIG. 7A and \textcircled{1} in FIG. 7B) as the contents of assembly buffer 235 are transferred to frame buffer 245 (block 710 in FIG. 7A and \textcircled{2} in FIG. 7B). Because, in accordance with the invention, programmable GPU 230 is used to apply the visual effect, virtually any visual effect may be used. Thus, while prior art systems are incapable of implementing sophisticated effects such as distortion, tile, gradient and blur effects, these are possible using the inventive technique. In particular, high-benefit visual effects for a full-screen effect in accordance with the invention include, but are not limited to, color correction and brightness effects. For example, it is known that liquid crystal displays (“LCDs”) have a non-uniform brightness characteristic across their surface. A full-screen effect in accordance with the invention could be used to remove this visual defect to provide a uniform brightness across the display's entire surface.

It will be recognized that, as a practical matter, full-screen visual effects must conform to the system's frame buffer scan rate. That is, suitable visual effects in accordance with 700 include those effects in which GPU 230 generates filter output at a rate faster than (or at least as fast as) data is removed from frame buffer 245. If GPU output is generated slower than data is withdrawn from frame buffer 245, potential display problems can arise. Accordingly, full-screen effects are generally limited to those effects that can be applied at a rate faster than the frame buffer's output scan rate.

Event routing in a system employing visual effects in accordance with the invention must be modified to account for post-application effects. Referring to FIG. 8, for example, application 210 may write into window buffer 220 such that window 800 includes button 805 at a particular location. After being modified in accordance with one or more of effects 300, 400, 600 and 700, display 250 may appear with button 805 modified to display as 810. Accordingly, if a user (the person viewing display 250) clicks on button 810, the system (i.e., the operating system) must be able to map the location of the mouse click into a location known by application 210 as corresponding to button 805 so that the application knows what action to take.

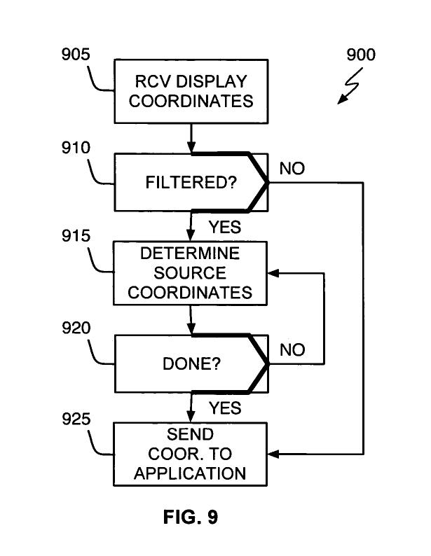

It will be recognized by those of ordinary skill in the art that filters (i.e., fragment programs implementing a desired visual effect) operate by calculating a destination pixel location (i.e., x_{d}, y_{d}) based on one or more source pixels. Accordingly, the filters used to generate the effects may also be used to determine the source location (coordinates). Referring to FIG. 9, event routing 900 in accordance with one embodiment of the invention begins when an event is detected (block 905). As used herein, an event may be described in terms of a “click” coordinate, e.g., (x_{click}, y_{click}). Initially, a check is made to determine if the clicked location comports with a filtered region of the display. If the clicked location (X_{click}, y_{click}) has not been subject to an effect (the “No” prong of block 910), the coordinate is simply passed to the appropriate application (block 925). If the clicked location (x_{click}, y_{click}) has been altered in accordance with the invention (the “Yes” prong of block 910), the last applied filter is used to determine a first tentative source coordinate (block 915). If the clicked location has not been subject to additional effects in accordance with the invention (the “Yes” prong of block 920), the first tentative calculated source coordinate is passed to the appropriate application (block 925). If the clicked location has been subject to additional effects in accordance with the invention (the “No” prong of block 920), the next most recently applied filter is used to calculate a second tentative source coordinate. Processing loop 915-920 is repeated for each filter applied to clicked location (x_{click}, y_{click}).

As noted above, display-wide visual effects in accordance with the invention may incorporate substantially any known visual effects. These include color effects, distortion effects, stylized effects, composition effects, half-tone effects, transition effects, tile effects, gradient effects, sharpen effects and blur effects.

Various changes in the components as well as in the details of the illustrated operational methods are possible without departing from the scope of the following claims. For instance, the illustrative system of FIG. 2, there may be additional assembly buffers, temporary buffers, frame buffers and/or GPUs. In addition, acts in accordance with FIGS. 3A, 4A, 6A, 7A and 9 may be performed by two or more cooperatively coupled GPUs and may, further, receive input from one or more system processing units (e.g., CPUs). It will further be understood that fragment programs may be organized into one or more modules and, as such, may be tangibly embodied as program code stored in any suitable storage device. Storage devices suitable for use in this manner include, but are not limited to: magnetic disks (fixed, floppy, and removable) and tape; optical media such as CD-ROMs and digital video disks (“DVDs”); and semiconductor memory devices such as Electrically Programmable Read-Only Memory (“EPROM”), Electrically Erasable Programmable Read-Only Memory (“EEPROM”), Programmable Gate Arrays and flash devices.

The preceding description was presented to enable any person skilled in the art to make and use the invention as claimed and is provided in the context of the particular examples discussed above, variations of which will be readily apparent to those skilled in the art. Accordingly, the claims appen ded hereto are not intended to be limited by the disclosed embodiments, but are to be accorded their widest scope consistent with the principles and features disclosed herein.

1. A method to generate a display-wide visual effect, comprising:
filtering an image buffer's contents using a graphics processing unit to generate a specified visual effect, wherein the image buffer is associated with a system frame buffer; and
compositing an application-specific window buffer into the image buffer, wherein the act of compositing is performed by the graphics processing unit after the act of filtering.

2. The method of claim 1, wherein the act of filtering comprises:
copying the image buffer's contents into a first buffer; and
filtering the first buffer's contents using the graphics processing unit back into the image buffer.

3. The method of claim 1, wherein the act of filtering comprises filtering less than all of the image buffer's contents.

4. The method of claim 1, wherein the specified visual effect comprises one or more of the following visual effects: color effects, distortion effects, stylized effects, composition effects, half-tone effects, transition effects, tile effects, gradient effects, sharpen effects and blur effects.

5. The method of claim 1, further comprising transferring contents of the image buffer to the system frame buffer after the act of compositing using the graphics processing unit.

6. A method to generate a display-wide visual effect, comprising:
filtering an application specific window buffer using a graphics processing unit to generate a specified visual effect; and
compositing, using a graphics processing unit, the filtered window buffer into an image buffer, said image buffer associated with a system frame buffer.

7. The method of claim 6, wherein the act of filtering comprises filtering less than all of the application specific window buffer's content.

8. The method of claim 6, wherein the specified visual effect comprises one or more of the following visual effects: color effects, distortion effects, stylized effects, composition effects, half-tone effects, transition effects, tile effects, gradient effects, sharpen effects and blur effects.

9. The method of claim 6, wherein the act of filtering comprises:
filtering, into a temporary buffer, the contents of the application specific window buffer and the contents of the image buffer into a temporary buffer substantially simultaneously with a graphics processing unit to generate a specified visual effect; and
transferring the contents of the temporary buffer into the image buffer using the graphics processing unit.

10. The method of claim 9, further comprising transferring contents of the image buffer into the system frame buffer after the act of compositing.

11. A method to generate a display-wide visual effect, comprising:
compositing an application specific window buffer into an image buffer, said image buffer associated with a system frame buffer; and
filtering the image buffer using a graphics processing unit to generate a specified visual effect.

12. The method of claim 11, wherein the act of filtering comprises:
copying the image buffer's contents into a first buffer; and
filtering the first buffer's contents using the graphics processing unit back into the image buffer.

13. The method of claim 12, wherein the act of filtering comprises filtering less than all of the application specific window buffer's content.

14. The method of claim 12, wherein the specified visual effect comprises one or more of the following visual effects: color effects, distortion effects, stylized effects, composition effects, half-tone effects, transition effects, tile effects, gradient effects, sharpen effects and blur effects.

15. A method to generate a display-wide visual effect, comprising:
filtering an image buffer using a graphics processing unit to generate a specified visual effect; and
storing the filtered image buffer into a frame buffer, said frame buffer associated with a display device.

16. The method of claim 15, wherein the act of filtering is performed in a time less than a scan rate associated with the frame buffer.

17. The method of claim 15, wherein the act of filtering comprises filtering less than all of the image buffer.

18. The method of claim 15, wherein the specified visual effect comprises one or more of the following visual effects: color effects, distortion effects, stylized effects, composition effects, half-tone effects, transition effects, tile effects, gradient effects, sharpen effects and blur effects.

19. A computer-readable medium having computer-executable instructions stored therein for performing the method recited in any one of claims 1, 5, 11 or 15.

20. A computer system, comprising:
a central processing unit;
memory, operatively coupled to the central processing unit, said memory adapted to provide a plurality of application-specific window buffers, at least one assembly buffer, and at least one frame buffer;
a display port operatively coupled to the frame buffer and adapted to couple to a display device;
a graphics processing unit, operatively coupled to the memory; and
one or more programs for causing the graphics processing unit to perform the method recited in any of claims 1, 6, 11 or 15.
